(19) United States
(12) Patent Application Publication
(10) Pub. No.: US 2026/0220452 A1
(43) Pub. Date: Jul. 30, 2026

(54) AUTOMATED TARGETED BENCHMARKING OF LANGUAGE MODELS

(71) Applicant: Cisco Technology, Inc., San Jose, CA (US)

(72) Inventors: Marcelo Yannuzzi, Nuvilly (CH); Arash Salarian, Chardonne (CH); Ali Payani, Cupertino, CA (US); Hervé Muyal, Gland (CH); Frank Brockners, Köln (DE)

(73) Assignee: Cisco Technology, Inc., San Jose, CA (US)

(21) Appl. No.: 19/039,601

(22) Filed: Jan. 28, 2025

(51) Int. Cl. G06N 3/08

(52) U.S. Cl. CPC G06N 3/08

(57) ABSTRACT

In one implementation, a device may select, based on a task specification associated with a fine-tuning operation for a language model, relevant benchmark datasets from a set of available benchmark datasets to be included in a benchmarking of a language model generated by the fine-tuning operation. The device may select a subset of samples from the relevant benchmark datasets to be included in the benchmarking of the language model generated by the fine-tuning operation. The device may cause the benchmarking of the language model generated by the fine-tuning operation using the subset of samples from the relevant benchmark datasets. The device may provide, based on outputs of the benchmarking of the language model, a summary of results of the benchmarking of the language model generated by the fine-tuning operation.

### TECHNICAL FIELD

The present disclosure relates generally to automated targeted benchmarking of language models.

### BACKGROUND

Machine learning models have become increasingly capable of performing complex tasks across a variety of domains. Pre-trained language large language models (LLMs) are typically equipped with certain foundational knowledge and skills. However, for usage in specific domains, enterprises often want to teach these models new skills and/or increase their knowledge using proprietary and/or domain-specific data sets. This process is referred to as fine-tuning. In machine learning, fine-tuning belongs to the large family of transfer learning methods.

Fine-tuning introduces a host of challenges, particularly when it comes to evaluating and benchmarking the performance of these models during the evolution of the model by the fine-tuning process. Benchmarking plays a critical role in determining whether the fine-tuned model has achieved the desired performance, identifying unintended regressions, and ensuring alignment with baseline expectations.

Existing approaches to benchmarking fine-tuned models are often resource-intensive and lack scalability. Evaluating extensive amounts of samples in common benchmark datasets across a wide range of tasks can take significant computational resources, making it impractical to benchmark models multiple times throughout a fine-tuning process. Furthermore, selecting the appropriate datasets and tasks for benchmarking requires substantial domain expertise, as many benchmarks overlap in scope, and not all tasks are equally important.

Another challenge lies in identifying unintended deviations in model performance during fine-tuning. Such deviations may result from issues like distribution shift of the fine-tuning dataset compared to the training dataset, imbalance in fine-tuning datasets, inappropriate hyperparameters, or inherent model limitations. Early detection of these issues is critical but difficult given the complexity of benchmarking processes and the vast amounts of data involved.

Finally, outcomes of benchmarking often produce large, complex datasets of metrics that are difficult to interpret. Practitioners face challenges in extracting actionable insights from these metrics, which can hinder decision-making during fine-tuning. As models and datasets continue to grow in size and complexity, the limitations of current benchmarking approaches and their effect on model performance become increasingly apparent.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of an architecture for model benchmarking;

FIG. 4 illustrates an example of an architecture for automated targeted benchmarking of language models;

FIG. 5 illustrates an example of a workflow in automated targeted benchmarking of language models; and

FIG. 6 illustrates an example simplified procedure for automated targeted benchmarking of language models, in accordance with one or more implementations described herein.

### DESCRIPTION OF EXAMPLE IMPLEMENTATIONS

### Overview

According to one or more implementations of the disclosure, a device may select, based on a task specification associated with a fine-tuning operation for a language model, relevant benchmark datasets from a set of available benchmark datasets to be included in a benchmarking of a language model generated by the fine-tuning operation. The device may select a subset of samples from the relevant benchmark datasets to be included in the benchmarking of the language model generated by the fine-tuning operation. The device may cause the benchmarking of the language model generated by the fine-tuning operation using the subset of samples from the relevant benchmark datasets. The device may provide, based on outputs of the benchmarking of the language model, a summary of results of the benchmarking of the language model generated by the fine-tuning operation.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

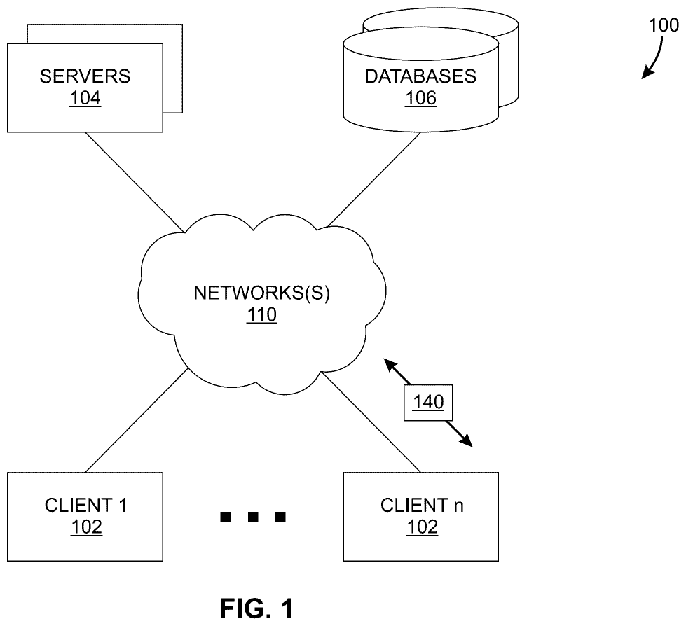

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

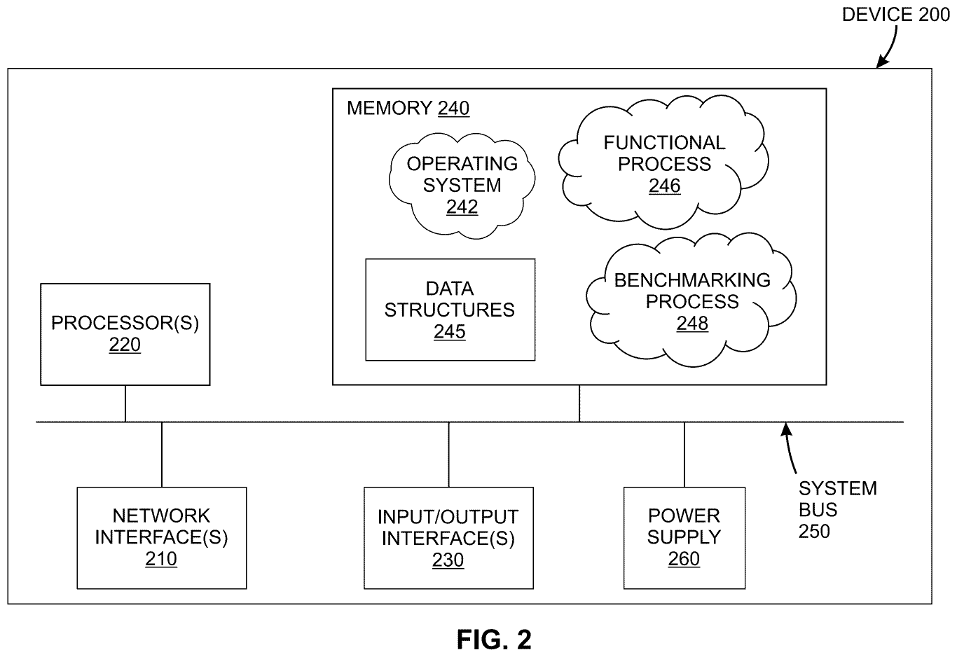

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, a benchmarking process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, benchmarking process 248 may include computer executable instructions that, when executed by processor 220, cause device 200 to perform the techniques described herein. To do so, in some implementations, benchmarking process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, benchmarking process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that benchmarking process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, benchmarking process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring LLM benchmarking, benchmarking process 248 may use a generative model to generate benchmark configurations based on a conversational input from a user (e.g., voice, text, etc.). Example generative approaches can include, but are not limited to, generative adversarial networks (GANs), large language models (LLMs), other transformer models, and the like.

### Model Benchmarking

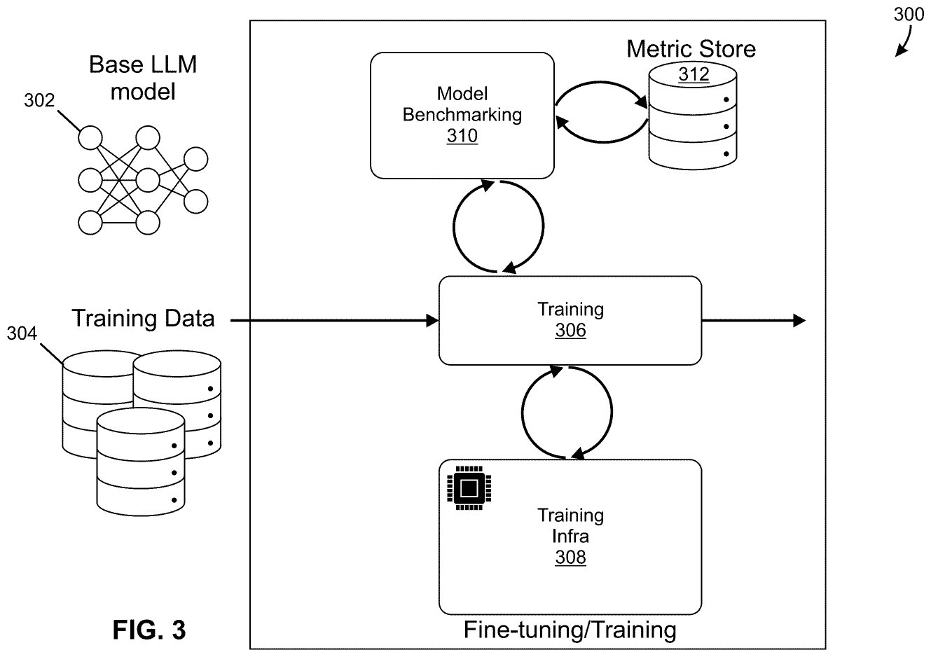

FIG. 3 illustrates an example of an architecture 300 for model benchmarking, in accordance with one or more implementations described herein. The architecture 300 may include a base language model 302 (e.g., a base LLM model). The base language model 302 may be a pre-trained LLM that has certain foundational knowledge and skills.

However, users (e.g., individual users, enterprises, etc.) may want the base language model 302 to be further trained or refined to meet specific requirements in specific domains that are beyond its foundational capabilities. The users may “teach” the base language model 302 the new skills and/or increase its knowledge using training data 304. The training data 304 may include proprietary and/or domain specific datasets that may be tailored to specific tasks, domains, or organizational objectives to enable the base language model 302 to perform new or improved targeted functions.

The training process 306 of targeted model enhancement may be referred to as fine-tuning and/or training. The training process 306 may be an iterative process where the base language model 302 is fine-tuned using the provided training data (e.g., training data 304), adjusting the base language model's parameters to improve performance on desired tasks.

The training process 306 may proceed by leveraging training infrastructure 308. Training infrastructure 308 may include computational infrastructure that can be used to train and/or fine-tune the base language model 302 using the training data 304. Examples of training infrastructure 308 may include necessary hardware, such as GPUs or TPUs, and software systems to handle the fine-tuning.

During and/or at the end of a training process 306, fine-tuned models and/or their intermediaries may be subjected to tests that are designed to ensure that the process has been successful. Broadly speaking, these tests may belong to one of two categories. Namely, a first category encompassing testing that measures the performance of the model for the newly learned task and/or a second category encompassing testing that checks whether the model's performance in the areas that it was pre-trained for has changed. Furthermore, users typically want to run comparisons and/or rank the model after fine-tuning, e.g., compared to base language model 302, previous fine-tuned versions, large proprietary models, other open-source models, etc.

To reduce computational costs, an approach may be to focus mainly on the direct aims of the fine-tuning (e.g., the first category). However, during fine-tuning, an unintended consequence may result whereby performance of the model might severely shift in certain domains. These unintended consequences (captured under the second category) could become mission critical.

Thus, capturing these deviations early in the process may represent a critical target. Indeed, changes or drops in the performance of the model on uncontrolled tasks could indicate issues in the statistical composition of the fine-tuning dataset, limitations in the model capacity compared to the complexity of the task, poor choices of the baseline, wrong fine-tuning hyper-parameters (e.g., too high of a learning rate, etc.), software bugs and system failures, or other reasons.

In architecture 300, this testing may be performed utilizing a model benchmarking component 310 and/or a metric store 312. The model benchmarking component 310 may evaluate the trained and/or fine-tuned model's performance on predefined metrics and/or tasks.

The data resulting from this testing may be used to assess whether the model meets baseline expectations and/or exhibits regressions in certain capabilities. The metric store 312 may include a storage system that records the benchmarking results and/or evaluation metrics from model benchmarking component 310. As such, the metric store 312 may serve as a repository for tracking performance over multiple iterations of fine-tuning and/or enable comparison with prior benchmarks.

As noted above, benchmarking presently represents a major challenge within the fine-tuning sphere. For instance, selecting a subset of common benchmarks to address the unintended consequences listed above is itself a challenge. Further, there are a large number of potential benchmarks, many of which have overlapping scope. Thus, there is a need for extensive NLP knowledge to select the right subset.

Further, not all tasks have the same importance. Indeed, intelligent, targeted compute resource utilization can be critical given the operational costs associated with conventional benchmarking approaches. Allocating more compute to the tasks that are more relevant can be a challenging endeavor, but one that may yield significant operational resource savings.

Furthermore, LLMs are frequently very large models. As such, running LLMs for inference can be very costly. The benchmark datasets commonly used in the ML community are also very large (e.g., typically tens or hundreds of thousands of question/response pairs). There is a large amount (e.g., two hundred plus) of well-recognized benchmark datasets across tens of tasks. For example, evaluating a benchmark for common sense reasoning (e.g., Hellaswag, etc.) for a small 7B parameters model can takes around two hours on an A100 GPU.

As result, simply running a model through all benchmarks, or even a few select ones, quickly becomes impractical. This is especially true since during fine-tuning enterprises may need to run benchmarking multiple times. For instance, benchmarking may be run on the baseline model, after each new version, after each change on the fine-tuning dataset, after changes in the benchmarking datasets, etc.

Consequently, conventional approaches to benchmarking are very compute heavy, they provide a quantity of metrics that is largely impractical to manage and interpret with conventional approaches, they include a tremendous amount of overlap, they are geared for use by highly knowledgeable experts, and/or they are not able to identify or address issues arising during training and/or fine tuning. Therefore, the performance of conventional approaches is diminished by these inefficiencies, resulting in significant resource wastage and delayed decision making.

The reliance on exhaustive evaluations across large, overlapping datasets leads to unsustainable computational costs, while the lack of intelligent task prioritization or subset selection often produced incomplete or misleading results. These shortcomings hinder timely identification of performance regressions and can obscure critical insights necessary for guiding effective model improvements. Often, when faced with these costs and shortcomings, some organizations avoid the benchmarking process altogether.

### Automated Targeted Benchmarking of Language Models

In contrast, the techniques described herein introduce automated targeted benchmarking of language models. This approach automates and optimizes the language model benchmarking process and includes techniques that facilitate experiment planning and sample selection during the benchmarking process. In various implementations, these techniques may be leveraged as design-time observability techniques to automate and optimize the LLM benchmarking process. The described techniques may be implemented during or after the fine-tuning process.

These techniques can provide observability into the quality of fine-tuning operations. Moreover, these techniques intelligently identify efficient and targeted benchmarks for a given task. Further, the techniques may significantly reduce the computation needs for repeated benchmarking and may simplify decision making by providing insights and summaries of the results.

In all, these techniques may lower the bar for entry by automating the process of benchmarking. Further, these techniques may result in lowered computational costs, intelligent task prioritization or subset selection, increased result accuracy, earlier and more accurate identification of performance regressions, critical insights necessary for guiding effective model improvements and/or increased adoption of benchmarking.

Illustratively, the techniques described herein may be performed by hardware, software, and/or firmware, such as in accordance with benchmarking process 248, which may include computer executable instructions executed by the processor 220 (or independent processor of interfaces 210) to perform functions relating to the techniques described herein.

Specifically, according to various implementations, a device may select, based on a task specification associated with a fine-tuning operation for a language model, relevant benchmark datasets from a set of available benchmark datasets to be included in a benchmarking of a language model generated by the fine-tuning operation. The device may select a subset of samples from the relevant benchmark datasets to be included in the benchmarking of the language model generated by the fine-tuning operation. The device may cause the benchmarking of the language model generated by the fine-tuning operation using the subset of samples from the relevant benchmark datasets. The device may provide, based on outputs of the benchmarking of the language model, a summary of results of the benchmarking of the language model generated by the fine-tuning operation.

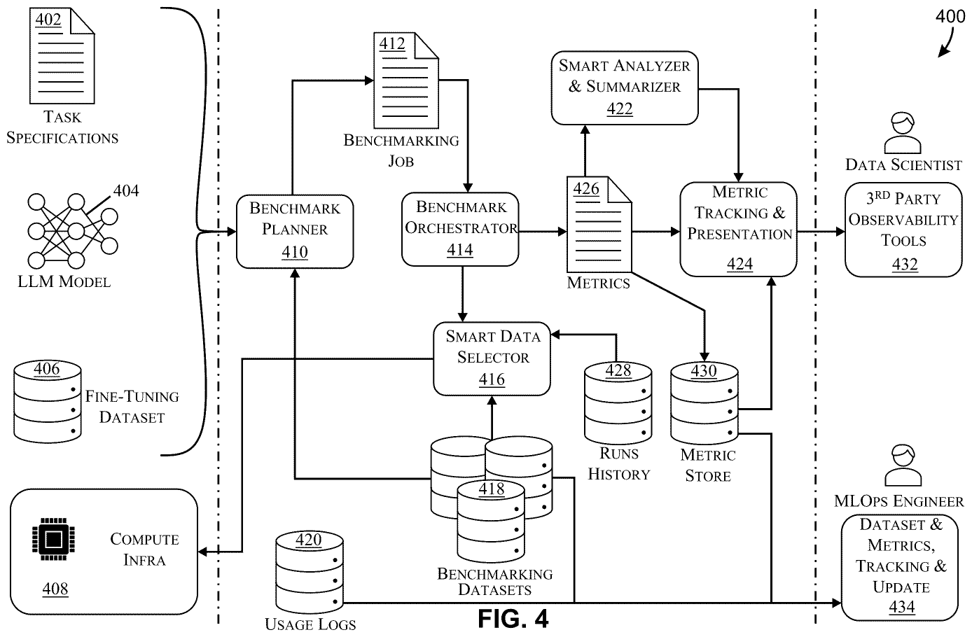

Operationally, FIG. 4 illustrates an example of an architecture 400 for automated targeted benchmarking of language models, in accordance with one or more implementations described herein. In architecture 400, a language model 404 (e.g., an LLM) may be fine-tuned on a targeted dataset (e.g., fine-tuning dataset 406). The fine-tuning dataset 406 may be accompanied by a job description and/or a task specification 402 that may encode the goals of the fine-tuning. This may encode the new skills that should be learned and the subset of existing skills of the pre-trained LLM language model that should be preserved (i.e., skills that were present in the LLM before the fine-tuning).

In various implementations, architecture 400 may include an external compute infrastructure 408 that may be utilized to run the fine-tuning process. In addition, the external compute infrastructure 408 may be utilized in the benchmarking operations during and/or after fine-tuning.

Architecture 400 may include a benchmark planner 410. The benchmark planner 410 may be a component of architecture 400 that configures aspects of the benchmarking process such as relevant dataset selection. For example, benchmark planner 410 may utilize a task specification 402 and/or the metadata associated with the benchmarking dataset (e.g., fine-tuning dataset 406), to dynamically select relevant datasets to be included in the benchmarking process. This may be captured and/or communicated in a benchmarking job description 412.

In addition, architecture 400 may include a smart data selector 416. The smart data selector 416 may be a component of architecture 400 that configures aspects of the benchmarking process such as sample dataset selection. For example, smart data selector 416 use the benchmarking job description 412, the benchmarking dataset metadata (e.g., benchmarking datasets 418), the history of the runs 428, and/or a set of heuristics to select a subset of the samples from each dataset. During the fine-tuning run, smart data selector 416 may monitor the outcomes and may either decide whether the run has sufficient statistical power. In the case that it doesn't, smart data selector 416 may opt to select the full datasets for benchmarking instead of just a sample. In various implementations, the heuristics for data subset selection may be a predictive model, pre-trained on the evaluation data from a collection of LLMs of varying size and architectures. In some implementations, the smart data selector 416 may include a trainable machine learning model, trained on history of the runs 428 to assign a rank or score to each data sample. These ranks or scores, may then be used together with a heuristic peak, for example, the most informative samples.

A benchmark orchestrator 414 may orchestrate the end-to-end process of evaluating a model's performance against predefined benchmarks. It may coordinate and/or cause the execution of various aspects of the benchmarking process. The benchmark orchestrator 414 may base its orchestration of the benchmarking operations on the benchmarking job description 412. The execution of the benchmarking operations may produce multiple outcome metrics (e.g., outcome metrics 426).

Architecture 400 may also include a smart analyzer and summarizer 422. Smart analyzer and summarizer 422 may be a component of architecture 400 that is configured to distill the benchmarking results (e.g., outcome metrics 426) into an easily consumable summary. For example, smart analyzer and summarizer 422 may use statistical methods to reduce the dimensionality of the benchmarking results (e.g., outcome metrics 426) and/or provide a more human readable and interpretable outcome. In various implementations, smart analyzer and summarizer 422 may use techniques based on factor analysis together with a heuristic method, which may itself be a predictive model for result summarization.

The outcome metrics 426, metrics from a metric store 430, and/or the output from the smart analyzer and summarizer 422 may be processed through a metric tracking and presentation component 424 and/or presented to a user (e.g., a data scientist) via observability tools 432. This outside-of-the-box analysis and summarization of metrics as well as their integration with metric visualization and tracking solutions may drastically simplify and increase the efficacy and speed of result interpretation.

In various implementations, data from usage logs 420, benchmarking datasets 418, and/or metric store 430 may be provided to a user (e.g., an MLOps engineer). This data may be utilized for dataset and metrics tracking and updating 434. For instance, this data may be leveraged for tracking, managing, and/or updating datasets and metrics used for model evaluation.

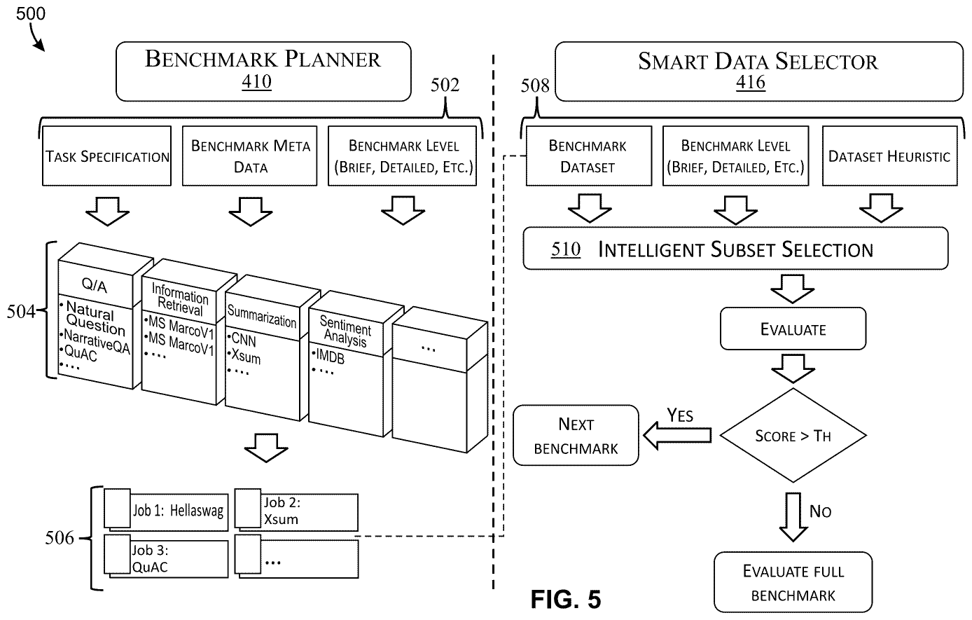

FIG. 5 illustrates an example of a workflow 500 in automated targeted benchmarking of language models, in accordance with one or more implementations described herein. In workflow 500, a benchmark planner 410 may perform dataset selection for a benchmarking operation. Benchmark planner 410 may utilize various inputs 502 (e.g., task specifications, benchmark metadata, targeted benchmark level indications, etc.) in selecting the datasets.

Using one or more of the various inputs 502, benchmark planner 410 may select relevant datasets 506. These may be a subset of datasets selected from the full set of available benchmarking datasets 504 that are most relevant to the particular benchmarking operation, data, goals, etc. Since a full evaluation of an LLM on all available benchmarking datasets is frequently impractical, the selection of a smaller relevant datasets can reduce the resource burden associated with benchmarking. This process may take in to account any overlap provided by potentially relevant datasets such that unnecessary duplication of computational efforts is avoided.

The relevant datasets 506, as well as benchmarking job description, the benchmarking dataset metadata, the history of the runs 428, the targeted benchmark level and/or a set of dataset heuristics may then be leveraged as inputs 508 for smart data selector 416 to select a subset of the samples from each dataset (e.g., intelligent subset selection 510). This process may take in to account any overlap provided by data subsets such that unnecessary duplication of computational efforts is avoided.

Intelligent subset selection 510 may use various factors including sample difficulty score and previous confidence of a model for that sample to select a minimal subset. Intelligent subset selection 510 may proceed by a comparison of these factors to a threshold value. If the threshold is met and/or exceeded for a particular subset, then the smart data selector 416 may select the evaluated subset for use in benchmarking and proceed to evaluating a next benchmark. However, if the threshold is not met and/or exceeded, then the smart data selector 416 may attempt to identify another subset to evaluate and/or trigger evaluation by the full benchmark.

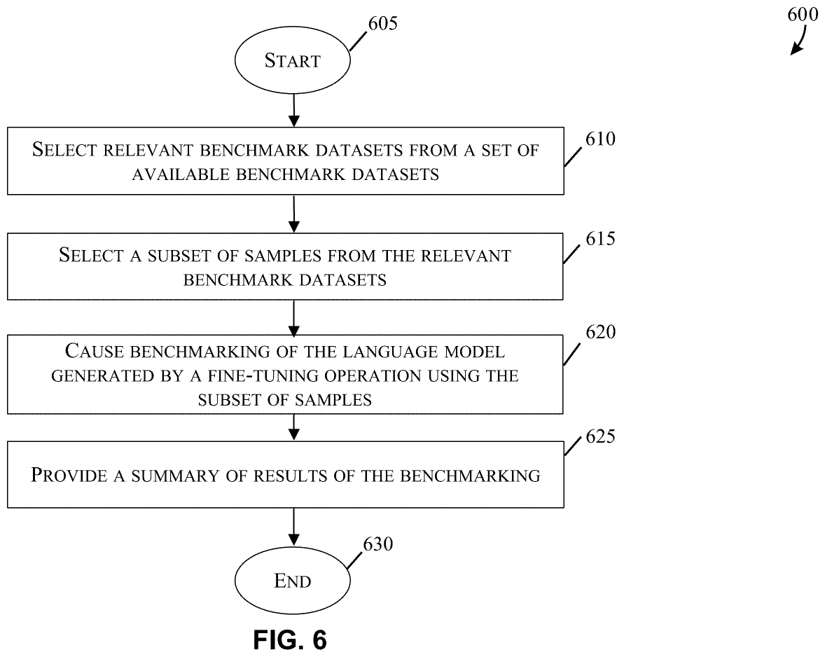

FIG. 6 illustrates an example of a simplified procedure for automated targeted benchmarking of language models, in accordance with one or more implementations described herein. For example, a non-generic, specifically configured device (e.g., device 200), may perform procedure 600 (e.g., a method) by executing stored instructions (e.g., benchmarking process 248).

The procedure 600 may start at step 605, and continues to step 610, where, as described in greater detail above, the device (e.g., a controller, processor, etc.) may select relevant benchmark datasets from a set of available benchmark datasets to be included in a benchmarking of a language model generated by a fine-tuning operation.

The selection may be based on a task specification associated with a fine-tuning operation for a language model. Further, the relevant benchmark datasets may be selected based on metadata associated with the set of available benchmark datasets.

At step 615, as detailed above, a device may select a subset of samples from the relevant benchmark datasets to be included in the benchmarking of the language model generated by the fine-tuning operation. The subset of samples may be selected based on a benchmark job description, metadata associated with the relevant benchmark datasets, a history of benchmarking runs, and/or a set of heuristics associated with the relevant benchmark datasets. The set of heuristics may be a predictive model pre-trained on evaluation data from a collection of language models of varying size and architectures.

At step 620, as detailed above, a device may cause the benchmarking of the language model generated by the fine-tuning operation using the subset of samples from the relevant benchmark datasets. The device may perform the benchmarking of the language model prior to completion of the fine-tuning operation. In some instances, the benchmarking of the language model may occur after a completion of the fine-tuning operation. That is, the benchmarking operations may be performed during and/or after fine-tuning of a language model.

In various implementations, a determination may be made as to whether an outcome of the benchmarking of the language model that was generated by the fine-tuning operation using the subset of samples from the relevant benchmark datasets satisfies a statistical power threshold. Then, responsive to a determination that the outcome for a run does not satisfy the statistical power threshold, another benchmarking run of the language model may be caused using complete relevant benchmark datasets instead. That is, if a run does not have sufficient statistical power, the full benchmark datasets may be selected for benchmarking of the model instead of just a sample of those datasets.

At step 625, as detailed above, the device may provide, based on outputs of the benchmarking of the language model, a summary of results of the benchmarking of the language model generated by the fine-tuning operation. The summary of results may be generated by reducing a dimensionality of the outputs of the benchmarking of the language model using a statistical method to produce a human readable summary. In various implementations, the summary of results may be generated using a predictive model, based on factor analysis together with a heuristic method, for result summarization.

Procedure 600 then ends at step 630.

It should be noted that while certain steps within procedure 600 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce intelligent benchmark planning, intelligent subset selection, intelligent summarization, and/or an end-to-end automation mechanism that can optimize the needed compute and/or synthesize a more effective understanding of benchmarking results. These techniques may significantly reduce the computation needs and avoid repeated benchmarking. Further, they may simplify decision making by providing insights and summaries of the results. In all, these techniques may lower the bar for entry by automating the process of benchmarking. A such, the techniques may result in lowered computational costs, intelligent task prioritization or subset selection, increased result accuracy, earlier and more accurate identification of performance regressions, critical insights necessary for guiding effective model improvements, and/or increased adoption of benchmarking.

While there have been shown and described illustrative implementations that provide for automated targeted benchmarking of language models, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
selecting, by a device and based on a task specification associated with a fine-tuning operation for a language model, relevant benchmark datasets from a set of available benchmark datasets to be included in a benchmarking of a language model generated by the fine-tuning operation;
selecting, by the device, a subset of samples from the relevant benchmark datasets to be included in the benchmarking of the language model generated by the fine-tuning operation;
causing, by the device, the benchmarking of the language model generated by the fine-tuning operation using the subset of samples from the relevant benchmark datasets; and
providing, by the device and based on outputs of the benchmarking of the language model, a summary of results of the benchmarking of the language model generated by the fine-tuning operation.

2. The method as in claim 1, wherein the device selects the relevant benchmark datasets based on metadata associated with the set of available benchmark datasets.

3. The method as in claim 1, wherein the device performs the benchmarking of the language model prior to completion of the fine-tuning operation.

4. The method as in claim 1, further comprising:
determining whether an outcome of the benchmarking of the language model that was generated by the fine-tuning operation using the subset of samples from the relevant benchmark datasets satisfies a statistical power threshold.

5. The method as in claim 4, further comprising:
causing, responsive to a determination that the outcome does not satisfy the statistical power threshold, benchmarking of the language model using complete relevant benchmark datasets.

6. The method as in claim 1, wherein the subset of samples is selected based on one or more of a benchmark job description, metadata associated with the relevant benchmark datasets, a history of benchmarking runs, or a set of heuristics associated with the relevant benchmark datasets.

7. The method as in claim 6, wherein the set of heuristics is a predictive model pre-trained on evaluation data from a collection of language models of varying size and architectures.

8. The method as in claim 1, further comprising:
generating the summary of results by reducing a dimensionality of the outputs of the benchmarking of the language model using a statistical method to produce a human readable summary.

9. The method as in claim 1, further comprising:
generating the summary of results using a predictive model, based on factor analysis together with a heuristic method, for result summarization.

10. The method as in claim 1, wherein the benchmarking of the language model is performed after a completion of the fine-tuning operation.

11. An apparatus, comprising:
one or more network interfaces;
a processor coupled to the one or more network interfaces and configured to execute one or more processes; and
a memory configured to store a process that is executable by the processor, the process when executed configured to:
select, based on a task specification associated with a fine-tuning operation for a language model, relevant benchmark datasets from a set of available benchmark datasets to be included in a benchmarking of a language model generated by the fine-tuning operation;
select a subset of samples from the relevant benchmark datasets to be included in the benchmarking of the language model generated by the fine-tuning operation;
cause the benchmarking of the language model generated by the fine-tuning operation using the subset of samples from the relevant benchmark datasets; and
provide, based on outputs of the benchmarking of the language model, a summary of results of the benchmarking of the language model generated by the fine-tuning operation.

12. The apparatus as in claim 11, wherein the apparatus selects the relevant benchmark datasets based on metadata associated with the set of available benchmark datasets.

13. The apparatus as in claim 11, wherein the apparatus performs the benchmarking of the language model prior to completion of the fine-tuning operation.

14. The apparatus as in claim 11, wherein the process when executed is further configured to:
determine whether an outcome of the benchmarking of the language model that was generated by the fine-tuning operation using the subset of samples from the relevant benchmark datasets satisfies a statistical power threshold.

15. The apparatus as in claim 14, wherein the process when executed is further configured to:
cause benchmarking of the language model using complete relevant benchmark datasets, responsive to a determination that the outcome does not satisfy the statistical power threshold.

16. The apparatus as in claim 11, wherein the subset of samples is selected based on one or more of a benchmark job description, metadata associated with the relevant benchmark datasets, a history of benchmarking runs, or a set of heuristics associated with the relevant benchmark datasets.

17. The apparatus as in claim 16, wherein the set of heuristics is a predictive model pre-trained on evaluation data from a collection of language models of varying size and architectures.

18. The apparatus as in claim 11, wherein the process when executed is further configured to:
generate the summary of results by reducing a dimensionality of the outputs of the benchmarking of the language model using a statistical method to produce a human readable summary.

19. The apparatus as in claim 18, wherein the process when executed is further configured to:
generate the summary of results using a predictive model, based on factor analysis together with a heuristic method, for result summarization.

20. A tangible, non-transitory, computer-readable medium storing program instructions that cause a device to execute a process comprising:
selecting, based on a task specification associated with a fine-tuning operation for a language model, relevant benchmark datasets from a set of available benchmark datasets to be included in a benchmarking of a language model generated by the fine-tuning operation;
selecting a subset of samples from the relevant benchmark datasets to be included in the benchmarking of the language model generated by the fine-tuning operation;
causing the benchmarking of the language model generated by the fine-tuning operation using the subset of samples from the relevant benchmark datasets; and
providing, based on outputs of the benchmarking of the language model, a summary of results of the benchmarking of the language model generated by the fine-tuning operation.
